(19) United States
(12) Patent Application Publication
(10) Pub. No.: US 2015/0372965 A1
(43) Pub. Date: Dec. 24, 2015

(54) METHOD OF INVITING OTHER ELECTRONIC DEVICES TO CHAT ROOM BY USING INFORMATION ON ACCESS POINT AND ELECTRONIC DEVICE THEREFOR

(71) Applicant: Samsung Electronics Co., Ltd, Gyeonggi-do (KR)

(72) Inventors: Young Kyu Seon, Gyeonggi-do (KR); Young Woon Lee, Gyeongsangbuk-do (KR)

(21) Appl. No.: 14/749,560

(22) Filed: Jun. 24, 2015

(30) Foreign Application Priority Data
Jun. 24, 2014 (KR) 10-2014-0077637

(51) Int. Cl. H04L 12/58; H04W 68/00; H04W 4/00; H04L 29/06; H04W 76/02

(52) U.S. Cl. CPC H04L 51/38; H04L 51/046; H04L 65/403; H04W 76/023; H04W 4/008; H04W 68/005; H04W 88/08

(57) ABSTRACT

A first electronic device is provided. The first electronic device includes a user input reception device configured to receive a user input to request the first electronic device to generate a chat room. The first electronic device also includes a processor configured to generate the chat room for use by a plurality of electronic devices. The first electronic device further includes a transmitter configured to broadcast information to provide a notification that the chat room is generated and to transmit the information to notify that the chat room is generated to an access point (AP) connected with the first electronic device.

### CROSS-REFERENCE TO RELATED APPLICATION AND CLAIM OF PRIORITY

The present application is related to and claims the benefit under 35 U.S.C. §119(a) of a Korean patent application filed on Jun. 24, 2014 in the Korean Intellectual Property Office and assigned Serial number 10-2014-0077637, the entire disclosure of which is hereby incorporated by reference.

### TECHNICAL FIELD

The present disclosure relates to a method of generating a chat room and connecting other electronic devices to the generated chat room using information about an access point (AP) and an electronic device therefor.

### BACKGROUND

Recently, as information communication technology has been developed, a plurality of network equipment, such as base stations and access points (APs), have been installed in all parts of the country. A user transmits and receives data with other users through his or her electronic device, using a network and the network equipment. The AP is an output device which plays a role as a base station in a wireless local area network (LAN), and plays a role as a bridge which connects a wired (or wireless) network with a wireless network. For example, the AP receives a cellular signal or a wired signal and generates a wireless-fidelity (Wi-Fi) zone around it. An electronic device which is located in the Wi-Fi zone transmits and receives data using a Wi-Fi network. In other words, the AP plays a role in expanding a wired and/or a wireless network to a free wireless network.

### SUMMARY

To address the above-discussed deficiencies, it is a primary object to provide at least the advantages described herein. Accordingly, an aspect of the present disclosure is to provide a method of inviting other electronic devices to a chat room using information about an AP and an electronic device therefor.

In first example, a first electronic device is provided. The first electronic device includes a user input reception module configured to receive a user input for requesting the first electronic device to generate a chat room. The first electronic device also includes a processor configured to generate the chat room in which a plurality of electronic devices will participate. The first electronic device further includes a transmission module configured to broadcast information for providing a notification that the chat room is generated and to transmit the information for providing the notification that the chat room is generated to an access point (AP) connected with the first electronic device.

In a second example, a second electronic device is provided. The second electronic device includes a reception module configured to receive information for providing a notification that a chat room is generated from a first electronic device through an AP connected with the second electronic device. The reception module is also configured to receive the information in a broadcasting manner from the first electronic device. The first electronic device broadcasts the information for providing the notification that the chat room is generated and transmits the information to an AP connected with the first electronic device.

In a third example, a method of providing a notification that a chat room is generated is provided. The method includes receiving a user input for requesting a first electronic device to generate the chat room. The method also includes generating the chat room in which a plurality of electronic devices will participate. The method further includes broadcasting information for providing the notification that the chat room is generated. The method includes transmitting the information for providing the notification that the chat room is generated to an access point (AP) that is connected to the first electronic device.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an example network environment including an electronic device according to various embodiments of the present disclosure;

FIG. 2 is a drawing illustrating an example chat room inviting system according to various embodiments of the present disclosure;

FIG. 3 is a drawing illustrating an example chat mom inviting system according to various embodiments of the present disclosure;

FIG. 4 is a block diagram illustrating a detailed configuration of an example host electronic device according to various embodiments of the present disclosure;

FIG. 5 is a block diagram illustrating a detailed configuration of an example second client electronic device according to various embodiments of the present disclosure;

FIG. 6 is a signal sequence diagram illustrating an example method of inviting a plurality of client electronic devices to a chat room at a host electronic device according to various embodiments of the present disclosure; and

FIG. 7 is a block diagram illustrating a configuration of an example electronic device according to various embodiments of the present disclosure.

Throughout the drawings, it should be noted that like reference numbers are used to depict the same or similar elements, features, and structures.

### DETAILED DESCRIPTION

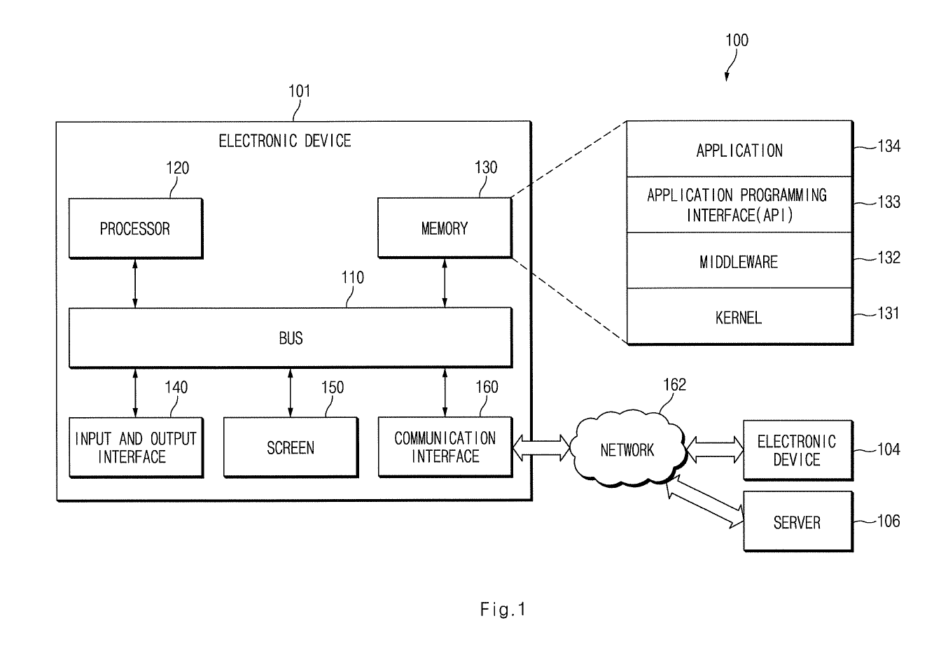

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device and communication system. Hereinafter, the present disclosure is described with reference to the accompanying drawings according to various embodiments of the present disclosure. Various modifications are possible in various embodiments of the present disclosure and embodiments are illustrated in drawings and related detailed descriptions are listed. However, the present disclosure is not intended to be limited to the specific embodiments, and it is understood that it should include various modifications, equivalents, and/or alternatives according to various embodiments of the present disclosure. With respect to the descriptions of the drawings, like reference numerals refer to like elements.

In the disclosure disclosed herein, the expressions “include” and “comprise”, or “may include” and “may comprise” used herein indicate existence of disclosed corresponding functions, operations, or elements, and the like but do not exclude presence of additional one or more functions, operations, or elements, and the like. Also, it should be understood that the terms “include” and “comprise”, “may include” and “may comprise”, or “have” and “may have” used herein specifies existence of stated features, integers, operations, elements, components, or combinations thereof but do not preclude the presence or addition of one or more other features, integers, operations, elements, components, or combinations thereof. The meaning of the expression “or” or “at least one of A or/and B” includes any or all combinations of words listed together with the expression. For example, the expression “A or B” or “at least one of A or/and B” may indicate A, B, or both A and B.

The expressions such as “1st”, “2nd”, “first”, or “second”, and the like used in various embodiments of the present disclosure may refer to various elements of various embodiments of the present disclosure, and may not limit the corresponding elements. For example, such expressions do not limit the order and/or priority of the corresponding elements. The expressions may be used to distinguish one element from another element. For instance, both “a first user device” and “a second user device” indicate electronic devices and different user devices from each other. For example, without departing from the scope of the present disclosure, a first element may be referred to as a second element and vice versa. It will be understood that when an element is referred to as being “connected to” or “coupled to” another element, it can be directly connected or coupled to the other element or an intervening element may be present. In contrast, when an element is referred to as being “directly connected to” or “directly coupled to” another element, it should be understood that there is no intervening element.

The terminology used herein is used to describe specified embodiments of the present disclosure and is not intended to limit the scope of the present disclosure. The terms of a singular form may include plural forms. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure.

A description will be given of electronic devices according to various embodiments of the present disclosure with reference to FIGS. 1 to 7. The electronic devices may be devices which may invite other electronic devices to a chat room using information about an access point (AP). For example, the electronic devices may include at least one of smartphones, smart pads, tablet personal computers (PCs), mobile phones, video telephones, electronic book readers, desktop PCs, laptop PCs, netbook computers, personal digital assistants (PDAs), portable multimedia players (PMPs), Motion Picture Experts Group (MPEG-1 or MPEG-2) Audio Layer 3 (MP3) players, mobile medical devices, cameras, or wearable devices (such as a head-mounted-devices (HMDs) such as smart glasses, an electronic apparel, electronic bracelets, electronic necklaces, electronic appcessories, or smart watches).

According to various embodiments of the present disclosure, the electronic devices may be smart home appliances which may invite other electronic devices to a chat room using information about an AP. The smart home appliances may include at least one of, for example, televisions (TVs), digital versatile disk (DVD) players, audios, refrigerators, air conditioners, cleaners, ovens, microwave ovens, washing machines, air cleaners, set-top boxes, TV boxes (such as SAMSUNG HOMESYNC™, APPLE TV™, or GOOGLE TV™), game consoles, electronic dictionaries, electronic keys, camcorders, or electronic picture frames.

According to various embodiments of the present disclosure, the electronic devices may include at least one of various medical devices (such as a magnetic resonance angiography (MRA), a magnetic resonance imaging (MRI), a computed tomography (CT), scanners, or ultrasonic devices, and the like), navigation devices, global positioning system (GPS) receivers, event data recorders (EDRs), flight data recorders (FDRs), vehicle infotainment devices, electronic equipment for vessels (such as navigation systems, gyrocompasses, and the like), avionics, security devices, head units for vehicles, industrial or home robots, automatic teller's machines (ATMs), or points of sales (POSs), which may invite other electronic devices to a chat room using information about an AP.

According to various embodiments of the present disclosure, the electronic devices may include at least one of parts of furniture or buildings/structures, electronic boards, electronic signature receiving devices, projectors, or various measuring instruments (such as water meters, electricity meters, gas meters, or wave meters, and the like), which may invite other electronic devices to a chat room using information about an AP. The electronic devices according to various embodiments of the present disclosure may be one or more combinations of the above-mentioned devices. The electronic devices according to various embodiments of the present disclosure may be flexible electronic devices. Also, it should be obvious to a person skilled in the art that electronic devices according to various embodiments of the present disclosure are not limited to the above-mentioned devices.

Hereinafter, electronic devices according to various embodiments of the present disclosure will be described with reference to the accompanying drawings. The term “user” used herein may refer to a person who uses an electronic device or may refer to a device (such as an artificial electronic device) that uses an electronic device.

FIG. 1 is a block diagram illustrating an example network environment including an electronic device according to various embodiments of the present disclosure. Referring to FIG. 1, an electronic device 101 may include a bus 110, a processor 120, a memory 130, an input and output interface 140, a screen 150, and a communication interface 160. The bus 110 may be a circuit that may connect the above-mentioned components with each other and may transmit communications (such as a control message) between the above-mentioned components.

The processor 120 may receive instructions from, for example, the above-mentioned other components (such as the memory 130, the input and output interface 140, the screen 150, or the communication interface 160, and the like) through the bus 110, may decode the received instructions, and may perform calculation or data processing according to the decoded instructions.

For example, the processor 120 may generate a chat room in which a plurality of electronic devices will participate. The processor 120 may generate the chat room according to a user input which requests it to generate the chat room. Also, the processor 120 may generate information for providing notification that the chat room is generated, and may transmit the generated information to an external device through the communication interface 160.

The memory 130 may store instructions or data which are received from the processor 120 or other components (such as the input and output interface 140, the screen 150, or the communication interface 160, and the like) or are generated by the processor 120 or the other components. The memory 130 may include, for example, programming modules 100, such as a kernel 131, a middleware 132, an application programming interface (API) 133, or an application 134. The above-mentioned respective programming modules 100 may be configured with software, firmware, hardware, or at least two or more combinations thereof.

The kernel 131 may control or manage system resources (such as the bus 110, the processor 120, or the memory 130, and the like) used to execute an operation or function implemented in the other programming modules, for example, the middleware 132, the API 133, or the application 134. Also, the kernel 131 may provide an interface which may access a separate component of the electronic device 101 in the middleware 132, the API 133, or the application 134 and may control or manage the separate component.

The middleware 132 may play a role as a go-between such that the API 133 or the application 134 communicates with the kernel 131 and transmits and receives data. Also, the middleware 132 may perform control (such as scheduling or load balancing) with respect to work requests using a method of assigning priority which may use system resources (the bus 110, the processor 120, or the memory 130, and the like) of the electronic device 101 to, for example, at least one of the application 134, in association with the work requests received from the application 134. The API 133 may be an interface in which the application 134 controls a function provided from the kernel 131 or the middleware 132. For example, the API 133 may include at least one interface or function (such as instruction) for file control, window control, image processing, or text control, and the like.

According to various embodiments of the present disclosure, the applications 134 may include a message application (such as a short message service/multimedia message service (SMS/MMS) application), an e-mail application, a calendar application, an alarm application, a health care application (such as an application for measuring quantity of exercise or blood sugar, and the like), or an environment information application (such as an application for providing atmospheric pressure information, humidity information, or temperature information, and the like), and the like. Additionally or alternatively, the application 134 may be an application associated with exchanging information between the electronic device 101 and an external electronic device (such as an electronic device 104 or a server 106). The application associated with exchanging the information may include, for example, a notification relay application for transmitting specific information to the external electronic device or a device management application for managing the external electronic device.

For example, the notification relay application may include a function of transmitting notification information, which is generated by other applications (such as the message application, the e-mail application, the health care application, or the environment information application, and the like) of the electronic device 101, to the external electronic device. Additionally or alternatively, the notification relay application may receive notification information from, for example, the external electronic device, and may provide the received notification information to a user of the electronic device 101. For example, the device management application may manage (such as install, delete, or update) a function (such as a function of turning on/off the external electronic device itself (or partial components) or a function of adjusting brightness (or resolution) of a display) for at least a part of the external electronic device which communicates with the electronic device 101, an application which operates in the external electronic device, or a service (such as a call service or a message service) provided from the external electronic device.

According to various embodiments of the present disclosure, the application 134 may include an application specified according to attributes (such as a kind of the electronic device) of the external electronic device. For example, if the external electronic device is an MP3 player, the application 134 may include an application associated with playing music. Similarly, when the external electronic device is a mobile medical device, the application 134 may include an application associated with health care. According to an embodiment of the present disclosure, the application 134 may include at least one of an application specified in the electronic device 101 and an application received from the external electronic device.

The input and output interface 140 may transmit instructions or data input from the user through an input and output device (such as a sensor, a keyboard, a touch screen, and the like) to, for example, the processor 120, the memory 130, or the communication interface 160 through the bus 110. For example, the input and output interface 140 may provide data about a touch of the user, which is input through the touch screen, to the processor 120. Also, the input and output interface 140 may output instructions or data received from, for example, the processor 120, the memory 130, or the communication interface 160 through the bus, through the input and output device (such as a speaker or a display). For example, the input and output interface 140 may output voice data processed through the processor 120 to the user through the speaker.

The screen 150 may display a variety of information (such as multimedia data, or text data, and the like) to the user. The communication interface 160 may perform communication between the electronic device 101 and the external electronic devices (such as the electronic device 104 or the server 106). For example, the communication interface 160 may connect to a network 162 through wireless communication or wired communication and may communicate with the external electronic device. The wireless communication may include at least one of, for example, wireless-fidelity (Wi-Fi) communication, BLUETOOTH® (BT) communication, near field communication (NFC), global positioning system (GPS) communication, and cellular communication (such as 3 generation (G), long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like). The wired communication may include at least one of, for example, a universal serial bus (USB), a high definition multimedia interface (HDMI), a recommended standard 232 (RS-232), and a plain old telephone service (POTS).

According to an embodiment of the present disclosure, the network 162 may be a telecommunications network. The telecommunications network may include at least one of a computer network, the Internet, the Internet of things, and a telephone network. According to an embodiment of the present disclosure, protocols (a transport layer protocol, a data link layer protocol, or a physical layer protocol, and the like) for communication between the electronic device 101 and the external electronic device may be supported in at least one of the application 134, the API 133, the middle ware 132, the kernel 131, or the communication interface 160.

According to various embodiments of the present disclosure, the server 106 may support the operation of the electronic device 101 by performing at least one of operations (or functions) implemented in the electronic device 101. For example, the server 106 may include a server module which may support the processor 120 implemented in the electronic device 101. For example, the server module may include at least one of components of the processor 120 and may perform (such as act as a proxy in) at least one of operations performed in the processor 120.

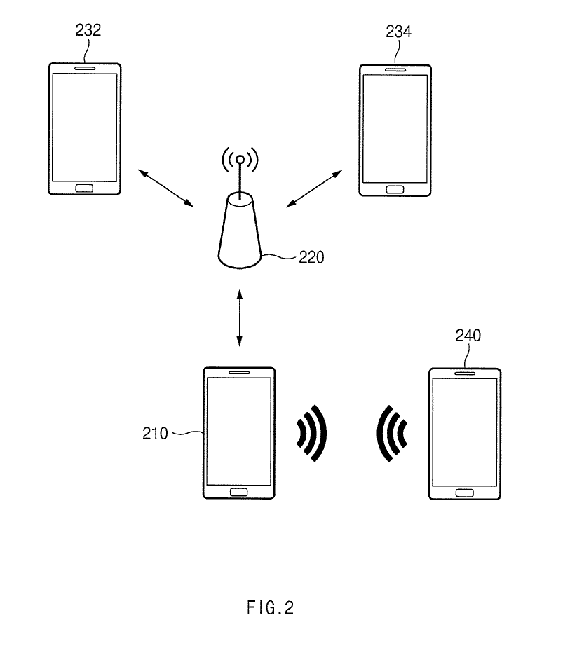

FIG. 2 is a drawing illustrating an example chat room inviting system according to various embodiments of the present disclosure. Referring to FIG. 2, a chat room inviting system may include a host electronic device 210, an AP 220, a first client electronic device 232, an electronic device 234, and a second client electronic device 240. Herein, because this chat room inviting system of FIG. 2 is only at least one of various embodiments of the present disclosure, it should be understood that the scope and spirit of the present disclosure may not be limited thereto. For example, the three electronic devices 210, 232, and 234 connect to the AP 220, but more electronic devices may connect to it. Also, although it is not shown in FIG. 2, the second client electronic device 240 may connect to another AP other than the AP 220.

The host electronic device 210 may generate a chat room, in which a plurality of electronic devices will participate, according to a user input which requests it to generate the chat room. Also, the host electronic device 210 may transmit information, for providing notification that the chat room is generated, to the AP 220 and the second client electronic device 240. In this case, the information transmitted from the host electronic device 210 to the AP 220 may be transmitted to the first client electronic device 232 and the electronic device 234 through the AP 220. Also, the information transmitted from the host electronic device 210 to the second client electronic device 240 may be transmitted in a broadcasting manner. For example, the host electronic device 210 may broadcast the information, for providing the notification that the chat room is generated, to the outside without specifying a called terminal. The second client electronic device 240 which is located within an effective distance from the host electronic device 210 may receive the information. In this case, other electronic devices which are located within the effective distance may also receive the information, as well as the second client electronic device 240, may receive the information. The broadcasting of the information may be performed in a BLUE TOOTH® low energy (BLE) network manner. Herein, when a BLE network is activated, the second client electronic device 240 and the other electronic devices, which are located within the effective distance from the host electronic device 210, may receive the information.

The AP 220 may receive the information, for providing the notification that the chat room is generated, from the host electronic device 210. Also, the AP 220 may transmit the received information, for providing the notification that the chat room is generated, to other electronic devices connected thereto. The AP 220 may transmit the information, for providing the notification that the chat room is generated, to the first client electronic device 232 and the electronic device 234 connected thereto. The host electronic device 210 also connects to the AP 220, but it may be excluded from devices to receive the information.

The first client electronic device 232 may receive the information, for providing the notification that the chat room is generated, from the AP 220. In this case, the information for providing the notification that the chat room is generated may include information which may access the chat room. The first client electronic device 232 may display at least a part of the received information on its screen. The first client electronic device 232 may receive a user input on the displayed information and may access the chat room according to the received user input. According to various embodiments of the present disclosure, the first client electronic device 232 may request the host electronic device 210 to participate in the chat room according to the user input. When the first client electronic device 232 is granted permission to participate in the chat room from the host electronic device 210, the first electronic device 232 may access the chat room.

The electronic device 234 may receive the information, for providing the notification that the chat room is generated, from the AP 220 and may display at least a part of the received information on its screen like the first client electronic device 232. Herein, the electronic device 234 may not participate in the chat room without receiving a user input on the displayed information or by receiving a user input denying the displayed information. The second client electronic device 240 may receive the information, for providing the notification that the chat room is generated, from the host electronic device 210. The second client electronic device 240 may connect to the host electronic device 210 through another AP. As described above, the second client electronic device 240 may receive the information in the broadcasting manner from the host electronic device.

The second client electronic device 240 may request the host electronic device 210 to transmit information of the chat room in response to receiving the information. The second client electronic device 240 may receive the information of the chat room and information of the AP 220 to which the host electronic device 210 connects from the host electronic device 210. The information of the chat room may include information which may access the chat room. Also, the information of the AP 220 may include information which may be granted permission to connect to the AP 220, such as a service set identifier (SSID). According to various embodiments of the present disclosure, the second client electronic device 240 may be paired with the host electronic device 210 using a BLUETOOTH® (BT) communication network, may request the host electronic device 210 to transmit the information of the chat room, and may receive the information of the chat room and the information of the AP 220 to which the host electronic device 210 connects. Herein, the request and reception of the information may not be limited to being performed using the BT communication network. For example, the request and reception of the information may be performed using a cellular network such as a 3 generation (G)/4G communication network or networks such as a near field communication (NFC) network and a Wi-Fi direct communication network.

The second client electronic device 240 may display at least a part of the received information of the chat room on its screen. The second client electronic device 240 may receive a user input on the displayed information. The second client electronic device 240 may connect to the AP 220 and may then access the chat room according to the user input. For example, the second client electronic device 240 may connect to the AP 220 using the received information of the AP 220 and may access the chat room using the received information of the chat room. According to various embodiments of the present disclosure, the second client electronic device 240 may request the host electronic device 210 to access the chat room according to the user input. In this case, when the second client electronic device 240 is granted permission to participate in the chat room from the host electronic device 210, it may access the chat room.

Because the amount of information which is transmitted through broadcasting on the BLE network is little, the host electronic device 210 may not transmit the information of the chat room and the information of the AP 220 to the second client electronic device 240. Accordingly, the second client electronic device 240 may receive the information from the host electronic device 210 through a separate session. The service for generating the chat room, inviting other electronic devices to the generated chat room, and in which the invited other electronic devices access the chat room may be provided through applications installed in the host electronic device 210, the first client electronic device 232, the electronic device 234, and the second client electronic device 240. Herein, the applications may mean application programs, and may include, for example, apps executed in electronic devices.

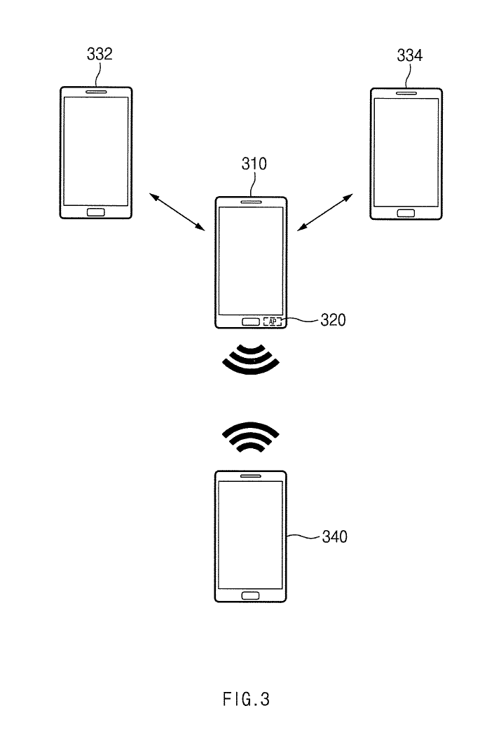

FIG. 3 is a drawing illustrating an example chat room inviting system according to various embodiments of the present disclosure. Referring to FIG. 3, a chat room inviting system may include a host electronic device 310, an AP 320, a first client electronic device 332, an electronic device 334, and a second client electronic device 340. Comparing the configuration of the chat room inviting system of FIG. 3 with the configuration of the chat room inviting system of FIG. 2, the AP 320 may be included in the host electronic device 310. For example, the host electronic device 310 may form a Wi-Fi zone around it using a hotspot service. Because each of the operations performed in the host electronic device 310, the AP 320, the first client electronic device 332, the electronic device 334, and the second client electronic device 340 corresponds to a corresponding one of the operations performed in the host electronic device 210, the AP 220, the first client electronic device 232, the electronic device 234, and the second client electronic device 240, which are shown in FIG. 2, an unnecessary description will be omitted.

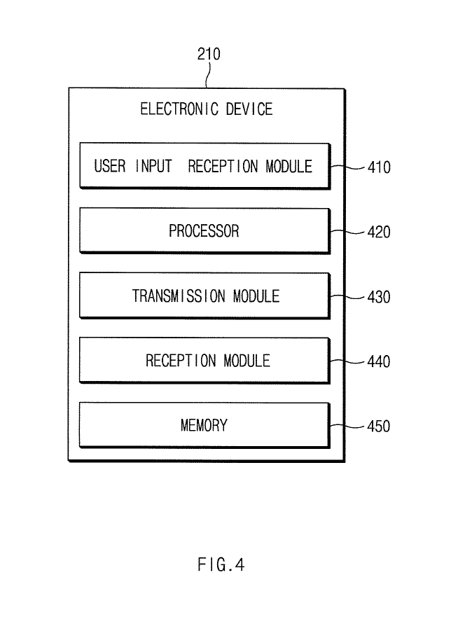

FIG. 4 is a block diagram illustrating a detailed configuration of an example host electronic device according to various embodiments of the present disclosure. Referring to FIG. 4, a host electronic device 210 may include a user input reception module 410, a processor 420, a transmission module 430, a reception module 440, and a memory 450. Herein, the host electronic device 210 shown in FIG. 4 is only at least one or more of various embodiments of the present disclosure. Several modifications are possible according to the components shown in FIG. 4.

For example, the host electronic device 210 may further include a user interface for receiving a certain instruction or certain information from a user. In this case, in general, the user interface may be an input device such as a keyboard and a mouse and may also be a graphic user interface (GUI) displayed on an image display device. The user input reception module 410 may receive a user input which requests the host electronic device 210 to generate a chat room. The user input may be input for touching a specific icon or a specific point on a screen of the host electronic device 210. Alternatively, the user input may be input for clicking a physical button installed in the host electronic device 210.

The processor 420 may generate a chat room, in which a plurality of electronic devices will participate, according to the user input. Also, the processor 420 may generate information for providing notification that the chat room is generated. The transmission module 430 may transmit the information, for providing the notification that the chat room is generated, to an AP 220 of FIG. 2 to which the host electronic device 210 connects. The AP 220 may transmit the received information to other electronic devices (such as a first client electronic device 232 of FIG. 2) connected thereto. The information for providing the notification that the chat room is generated, which is transmitted to the AP 220, may include information which may access the chat room.

Also, the transmission module 430 may broadcast the information for providing the notification that the chat room is generated, which is generated by the processor 420. The broadcasting of the information may be performed in a BLE network manner. Herein, the broadcasted information may arrive at a second client electronic device 240 of FIG. 2.

The reception module 440 may receive a request to participate in the chat room from the first client electronic device 232. Also, the reception module 440 may receive a request to transmit information of the chat room from the second client electronic device 240 which receives the broadcasted signal. The transmission module 430 may transmit the information of the chat room and information of the AP 220, to which the host electronic device 210 connects, to the second client electronic device 240. The request to transmit the information of the chat room may be received through a BT communication network. For example, before receiving the request to transmit the information of the chat room, the reception module 440 may first receive a request to perform BT pairing from the second client electronic device 240. Thereafter, the reception module 440 may receive the request to participate in the chat room from the second client electronic device 240. As described above, the second client electronic device 240 may first connect to the AP 220 and may then access the chat room.

An amount of information which may be transmitted through the AP 220 is more than an amount of information which may be broadcasted through a BLE network. Accordingly, receiving information through the AP 220, the first client electronic device 232 may also receive information which may access the chat room. In other words, although the first client electronic device 232 does not receive the information broadcasted from the host electronic device 210, it may access the chat room. In contrast, if the second client electronic device 240 which does connect to the AP 220 does not receive the information broadcasted from the host electronic device 210, it may not access the chat room.

The memory 450 may store at least one or more data by the processor 420. Herein, the data stored in the memory 450 may include data input and output between the respective components in the host electronic device 210, and may include data input and output between the host electronic device 210 and components out of the host electronic device 210. For example, the memory 450 may store information about the generated chat room, and may store information about APs to which the host electronic device 210 connects, and the like. The memory 450 may include a hard disc drive, a read only memory (ROM), a random access memory (RAM), a flash memory, a memory card, and the like, which are in or out of the host electronic device 210. It should be fully understood to a person skilled in the art that the user input reception module 410, the processor 420, the transmission module 430, the reception module 440, and the memory 450 may be implemented to be independent of each other or that one or more of them may be implemented to be integrated with each other.

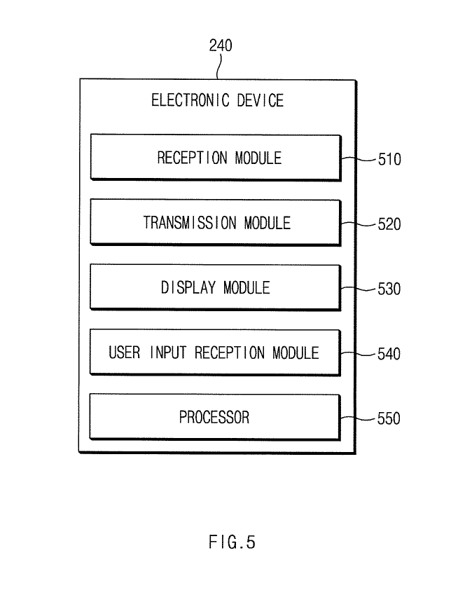

FIG. 5 is a block diagram illustrating a detailed configuration of an example second client electronic device according to various embodiments of the present disclosure. Referring to FIG. 5, a second client electronic device 240 may include a reception module 510, a transmission module 520, a display module 530, a user input reception module 540, a processor 550, and a memory. Herein, the second client electronic device 240 shown in FIG. 5 is only at least one or more of various embodiments of the present disclosure. Several modifications are possible according to the components shown in FIG. 5. For example, the second client electronic device 240 may further include a user interface for receiving a certain instruction and certain information from a user like the description of FIG. 4.

The reception module 510 may receive information, for providing notification that a chat room is generated, in a broadcasting manner from a host electronic device 210 of FIG. 2. If the second client electronic device 240 connects to an AP 220 of FIG. 2 to which the host electronic device 210 connects, it may receive the information, for providing the notification that the chat room is generated, through the AP 220. When the reception module 510 receives the information, for providing the notification that the chat room is generated, in the broadcasting manner, the transmission module 520 may request the host electronic device 210 to transmit information of the chat room. The request to transmit the information of the chat room may be performed through a BT communication network. Accordingly, BT pairing between the second client electronic device 240 and the host electronic device 210 may be first performed. The reception module 510 may receive the information of the chat room and information of the AP 220 from the host electronic device 210 in response to the request to transmit the chat room.

The display module 530 may display the received information of the chat room on its screen. The displayed information of the chat room may include a name of a chat room specified by the host electronic device 210, and the like. Also, the information of the chat room may be displayed as a chat room user interface (UI). The chat room UI may be an icon which may select whether to participate in the chat room. According to various embodiments of the present disclosure, when there are a plurality of host electronic devices, the second client electronic device 240 may receive information about a chat room generated by each of the plurality of host electronic devices. In this case, the display module 530 may allow a user to select one chat room by displaying information about the chat rooms on a list.

The user input reception module 540 may receive a user input on the displayed information about the chat room. For example, the user input reception module 540 may receive user input for accessing the chat room or user input for denying access to the chat room. Also, when there are several chat room lists, the user input reception module 540 may receive a user input for selecting one of a plurality of chat rooms. Thereafter, the user input reception module 540 may further receive a user input for selecting whether to access the selected chat room. When the user input for accessing the chat room is received, the processor 550 may connect to the AP 220 using the received AP information and may then access the chat room using the received information on the chat room.

When the connection to the AP 220 using the received AP information fails, the processor 550 may attempt to connect to an internet protocol (IP)/port to which the AP 220 connects. When network units are different from each other, the above-mentioned failure may occur. Information about the IP/port may be included in the received information of the AP 220. Also, the processor 550 may determine whether the AP received information is information about an AP to which the second client electronic device 240 may connect. For example, the AP 220, to which the host electronic device 210 connects, uses a Wi-Fi network signal of 5 GHz. However, if the second client electronic device 240 does not support the Wi-Fi network signal of 5 GHz, it may not connect to the AP 220. Also, when the second client electronic device 240 is distant from the AP 220, it may not receive a Wi-Fi signal generated by the AP 220 and may not connect to the AP 220. As such, when the second client electronic device 240 may not connect to an AP corresponding to the received AP information, the processor 550 may determine not to display the received information on the chat room on a screen of the second client electronic device 240.

The memory may store at least one or more data by the processor 550 like a memory 450 of FIG. 4. Herein, the data stored in the memory may include data input and output between the respective components in the second client electronic device 240 and may include data input and output between the second client electronic device 240 and components out of the second client electronic device 240. It should be understood to a person skilled in the art that the reception module 510, the transmission module 520, the display module 530, the user input reception module 540, the processor 550, and the memory may be implemented to be independent of each other or that one or more of them may be implemented to be integrated with each other.

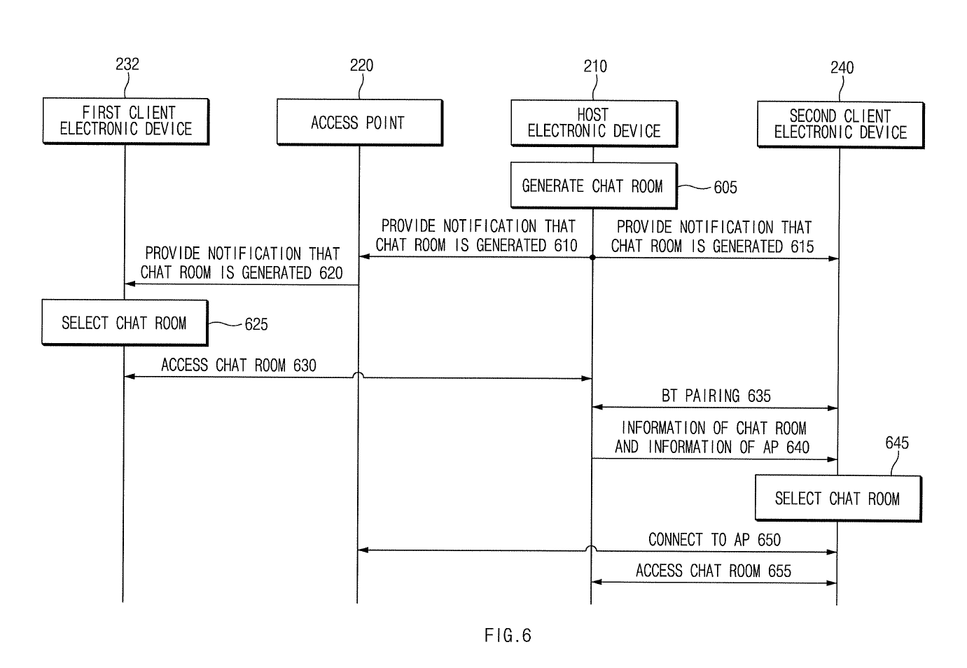

FIG. 6 is a signal sequence diagram illustrating an example method of inviting a plurality of client electronic devices to a chat room at a host electronic device according to various embodiments of the present disclosure. A method of inviting a plurality of client electronic devices to a chat room at a host electronic device 210 according to an embodiment of the present disclosure shown in FIG. 6 may include time series operations in a host electronic device 210, an AP 220, a first client electronic device 232, an electronic device 234, and the second client electronic device 240 according to various embodiments of the present disclosure are shown in FIGS. 1 to 5. Accordingly, although there are contents omitted below, contents described about the host electronic device 210, the AP 220, the first client electronic device 232, the electronic device 234, and the second client electronic device 240 according to various embodiments of the present disclosure shown in FIGS. 1 to 5 may be applied to the method of inviting the plurality of client electronic devices to the chat room at the host electronic device 210 according to an embodiment of the present disclosure shown in FIG. 6.

In operation 605, the host electronic device 210 may generate a chat room. In operation 610, the host electronic device 210 may transmit information, for providing notification that the chat room is generated, to an AP 220. The information for providing the notification that the chat room is generated may include information about the chat room. In operation 615, the host electronic device 210 may broadcast the information for providing the notification that the chat room is generated to be transmitted to a second client electronic device 240. The broadcasting of the information may be performed in a BLE network manner. FIG. 6 illustrates an example in which operation 610 and operation 615 are simultaneously performed. However, the scope and spirit of the present disclosure may not be limited thereto. For example, operation 610 and operation 615 may be successively performed.

In operation 620, the AP 220 may transmit the information for providing the notification that the chat room is generated, which is transmitted in operation 610, to a first client electronic device 232. In operation 625, the first client electronic device 232 may display the information for providing the notification that the chat room is generated, which is transmitted in operation 620, on its screen to select access to the chat room. In operation 630, the first client electronic device 232 may access the chat room generated by the host electronic device 210 according to the selection in operation 625. According to various embodiments of the present disclosure, the access to the chat room at the first client electronic device 232 may be performed after the host electronic device 210 grants the access to the chat room. In other words, the information for providing the notification that the chat room is generated is transmitted to a plurality of electronic devices connected to the AP 220 in operation 610 because electronic devices which must not participate in the chat room may access the chat room.

In operation 635, the second client electronic device 240 and the host electronic device 210 may perform BT pairing. Herein, to perform the BT pairing, the second client electronic device 240 may first request the host electronic device 210 to perform the BT pairing. Also, FIG. 6 illustrates an example in which operation 635 is later performed in comparison with operations 620, 625, and 630. The scope and spirit of the present disclosure may not be limited thereto. For example, operation 635 may be performed faster than operation 620 and may be performed simultaneously with operation 620. Operations 610, 620, and 630 and operations 615, 635, 640, 645, 650, and 655 may be performed to be independent of each other.

In operation 640, the host electronic device 210 may transmit the information of the chat room and the information about the AP 220 to the second client electronic device 240. According to various embodiments of the present disclosure, the transmission of the information of the chat room and the information about the AP 220 may be performed by a request of the second client electronic device 240 to the host electronic device 210. In operation 645, the second client electronic device 240 may display the information of the chat room, which is transmitted in operation 640, on its screen and may select the chat room through a user input for participating in the chat room.

In operation 650, the second client electronic device 240 may connect to the AP 220 using the information about the AP 220, which is transmitted in operation 640. According to various embodiments of the present disclosure, the second client electronic device 240 may release connection with an AP previously connected thereto and may newly connect to the AP 220. In operation 655, the second client electronic device 240 may access the chat room generated by the host electronic device 210 according to the selection in operation 645 using the information of the chat room, which is transmitted in operation 640.

An order of operations 605 to 655 shown in FIG. 6 may be only at least one or more of various embodiments of the present disclosure. The scope and spirit of the present disclosure may not be limited thereto. For example, orders between the above-mentioned operations may be changed to each other, and some of the operations may be simultaneously performed. The above-mentioned operations may be repeated at a predetermined time, and may be performed again according to a user input. Also, at least a part of the above-mentioned operations may be omitted.

The first electronic device according to various embodiments of the present disclosure may include the user input reception module which receives a user input for requesting the first electronic device to generate a chat room, the processor which generates the chat room in which a plurality of electronic devices will participate, and the transmission module which broadcasts information for providing notification that the chat room is generated and transmits the information, for providing the notification that the chat room is generated, to an AP to which the first electronic device connects. The broadcasting of the information may be performed in a BLUETOOTH® low energy (BLE) network manner. According to various embodiments of the present disclosure, the information for providing the notification that the chat room is generated, which is transmitted to the AP, may be transmitted to other electronic devices connected to the AP. According to various embodiments of the present disclosure, the information for providing the notification that the chat room is generated, which is transmitted to the AP, may include information which may access the chat room.

The first electronic device according to various embodiments of the present disclosure may further include the reception module which receives a request to transmit information of the chat room from the second electronic device which receives the broadcasted information. In this case, the transmission module may transmit the information of the chat room and information about the AP, to which the first electronic device connects, to the second electronic device. Herein, the reception module may receive a request to perform BT pairing from the second electronic device. The request to transmit the information of the chat room may be received through a BT communication network. According to various embodiments of the present disclosure, the AP to which the first electronic device connects may be the first electronic device itself or may be included in the first electronic device.

The second electronic device according to various embodiments of the present disclosure may include the reception module which receives information, for providing notification that a chat room is generated, from the first electronic device through an AP to which the second electronic device connects or receives the information in a broadcasting manner from the first electronic device. In this case, the first electronic device may broadcast the information for providing the notification that the chat room is generated and may transmit the information to an AP to which the first electronic device connects.

When the first electronic device and the second electronic device connect to the same AP, the reception module according to various embodiments of the present disclosure may receive the information, for providing the notification that the chat room is generated, through the AP. The second electronic device according to various embodiments of the present disclosure may further include the transmission module which transmits a request to transmit information of the chat room to the first electronic device when the reception module receives the information, for providing the notification that the chat room is generated, in the broadcasting manner. The reception module may receive the information of the chat room and information about the AP to which the first electronic device connects.

The second electronic device according to various embodiments of the present disclosure may further include the display module which displays the received information of the chat room on its screen, the user input reception module which receives a user input on the displayed information of the chat room, and the processor which connects to the AP using the received information of the AP and accesses the chat room using the received information of the chat room.

The processor according to various embodiments of the present disclosure may determine whether the received information of the AP is information about an AP to which the second electronic device may connect and when the received information of the AP is not the information as a result of the determination, may determine not to display the received information of the chat room on the screen. According to various embodiments of the present disclosure, when the connection to the AP fails because network units are different from each other, the processor may attempt to connect to an IP/port to which the AP connects.

The method for providing notification that a chat room is generated according to various embodiments of the present disclosure may include receiving a user input for requesting a first electronic device to generate the chat room, generating the chat room in which a plurality of electronic devices will participate, broadcasting information for providing the notification that the chart room is generated, and transmitting the information, for providing the notification that the chart room is generated, to an AP to which the first electronic device connects.

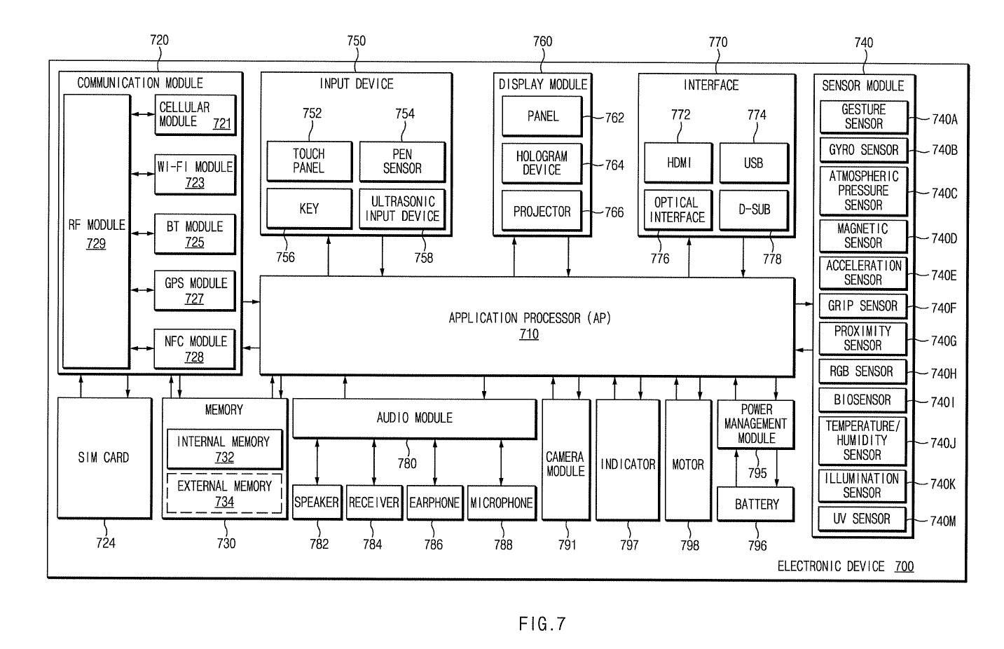

FIG. 7 is a block diagram illustrating a configuration of an example electronic device according to various embodiments of the present disclosure. An electronic device 700 may include, for example, all or a part of an electronic device 101 shown in FIG. 1. Referring to FIG. 7, the electronic device 700 may include one or more application processors (APs) 710, a communication module 720, a subscriber identification module (SIM) card 724, a memory 730, a sensor module 740, an input device 750, a display module 760, an interface 770, an audio module 780, a camera module 791, a power management module 795, a battery 796, an indicator 797, and a motor 798.

The AP 710 may run an operating system (OS) or an application program to control a plurality of hardware or software components connected thereto and may process and compute a variety of data including multimedia data. The AP 710 may be implemented with, for example, a system on chip (SoC). According to an embodiment of the present disclosure, the AP 710 may further include a graphic processing unit (GPU).

The communication module 720 (such as a communication interface 160 of FIG. 1) may transmit and receive data in communication between the electronic device 700 (such as the electronic device 101) and another electronic device (such as an electronic device 104 of FIG. 1 or a server 106 of FIG. 1) connected through a network (such as a network of FIG. 1). According to an embodiment of the present disclosure, the communication module 720 may include a cellular module 721, a wireless-fidelity (Wi-Fi) module 723, a BLUETOOTH® (BT) module 725, a global positioning system (GPS) module 727, a near field communication (NFC) module 728, and a radio frequency (RF) module 729.

The cellular module 721 may provide a voice call service, a video call service, a text message service, or an Internet service, and the like through a communication network (such as long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like). Also, the cellular module 721 may identify and authenticate the electronic device 700 in a communication network using a subscriber identification module (such as the SIM card 724). According to an embodiment of the present disclosure, the cellular module 721 may perform at least a part of functions which may be provided by the AP 710. For example, the cellular module 721 may perform at least a part of a multimedia control function.

According to an embodiment of the present disclosure, the cellular module 721 may include a communication processor (CP). Also, the cellular module 721 may be implemented with, for example, an SoC. FIG. 7 illustrates an example in which components such as the cellular module 721 (such as the CP), the memory 730, or the power management module 795 are configured to be independent of the AP 730. According to an embodiment of the present disclosure, the AP 710 may be implemented to include at least a part (such as the cellular module 721) of the above-mentioned components.

According to an embodiment of the present disclosure, the AP 710 or the cellular module 721 (such as the CP) may load instructions or data received from at least one of a non-volatile memory or another component connected thereto into a volatile memory to process the instructions or the data. Also, the AP 710 or the cellular module 721 may store data, which are received from at least one of other components or are generated by at least one of the other components, in a non-volatile memory.

The Wi-Fi module 723, the BT module 725, the GPS module 727, or the NFC module 728 may include, for example, a processor for processing data transmitted and received through the corresponding module. FIG. 7 illustrates an example in which the cellular module 721, the Wi-Fi module 723, the BT module 725, the GPS module 727, and the NFC module 728 are independent of each other. According to an embodiment of the present disclosure, at least a part (such as two or more) of the cellular module 721, the Wi-Fi module 723, the BT module 725, the GPS module 727, or the NFC module 728 may be included in one integrated chip (IC) or an IC package. For example, at least a part (the CP corresponding to the cellular module 721 and a Wi-Fi processor corresponding to the Wi-Fi module 723) of the processors corresponding to the cellular module 721, the Wi-Fi module 723, the BT module 725, the GPS module 727, and the NFC module 728 may be implemented with one SoC.

The RF module 729 may transmit and receive data, for example, an RF signal. Though not shown, the RF module 729 may include, for example, a transceiver, a power amplifier module (PAM), a frequency filter, or a low noise amplifier (LNA), and the like. Also, the RF module 729 may further include components, for example, conductors or conducting wires, and the like, for transmitting and receiving electromagnetic waves on the free space in wireless communication. FIG. 7 illustrates an example in which the cellular module 721, the Wi-Fi module 723, the BT module 725, the GPS module 727, and the NFC module 728 share the one RF module 729 with each other. According to an embodiment of the present disclosure, at least one of the cellular module 721, the Wi-Fi module 723, the BT module 725, the GPS module 727, or the NFC module 728 may transmit and receive an RF signal through a separate RF module.

The SIM card 724 may be a card which includes a SIM and may be inserted into a slot formed in a specific position of the electronic device 700. The SIM card 724 may include unique identification information (such as an integrated circuit card identifier (ICCID)) or subscriber information (such as an international mobile subscriber identity (IMSI)).

The memory 730 (such as a memory 130 of FIG. 1) may include an embedded memory 732 or an external memory 734. The embedded memory 732 may include at least one of, for example, a volatile memory (such as a dynamic random access memory (DRAM), a static RAM (SRAM), a synchronous dynamic RAM (SDRAM), and the like), or a non-volatile memory (such as a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, a NOR flash memory, and the like).

According to an embodiment of the present disclosure, the embedded memory 732 may be a solid state drive (SSD). The external memory 734 may further include a flash drive, for example, a compact flash (CF), a secure digital (SD), a micro-SD, a mini-SD, an extreme digital (xD), or a memory stick, and the like. The external memory 734 may functionally connect with the electronic device 700 through various interfaces. According to an embodiment of the present disclosure, the electronic device 700 may further include a storage device (or a storage medium) such as a hard drive.

The sensor module 740 may measure a physical quantity or may detect an operation state of the electronic device 700, and may convert the measured or detected information to an electric signal. The sensor module 740 may include at least one of, for example, a gesture sensor 740A, a gyro sensor 740B, an atmospheric pressure sensor 740C, a magnetic sensor 740D, an acceleration sensor 740E, a grip sensor 740F, a proximity sensor 740G, a color sensor 740H (such as red, green, blue (RGB) sensor), a biosensor 740I, a temperature/humidity sensor 740J, an illumination sensor 740K, or an ultraviolet (UV) sensor 740M. Additionally or alternatively, the sensor module 740 may further include, for example, an e-nose sensor, an electromyography (EMG) sensor, an electroencephalogram (EEG) sensor, an electrocardiogram (ECG) sensor, an infrared (IR) sensor, an iris sensor, or a fingerprint sensor, and the like. The sensor module 740 may further include a control circuit for controlling at least one or more sensors included therein.

The input device 750 may include a touch panel 752, a (digital) pen sensor 754, a key 756, or an ultrasonic input unit 758. The touch panel 752 may recognize touch input using at least one of, for example, a capacitive detecting method, a resistive detecting method, an infrared detecting method, or a ultrasonic detecting method. Also, the touch panel 752 may further include a control circuit. In case of the capacitive detecting method, the touch panel 752 may recognize touch input through a physical contact and proximity recognition. The touch panel 752 may further include a tactile layer. In this case, the touch panel 752 may provide a tactile reaction to a user.

The (digital) pen sensor 754 may be implemented using, for example, the same or similar method as or to a method of receiving touch input of the user or a separate sheet for recognition. The key 756 may include, for example, a physical button, an optical key, or a keypad. The ultrasonic input unit 758 may be a device, which allows the electronic device 700 to detect a sound wave using a microphone (such as a microphone 788) and to determine data through an input tool generating an ultrasonic signal. The ultrasonic input unit 758 may perform wireless recognition. According to an embodiment of the present disclosure, the electronic device 700 may receive a user input from an external device (such as a computer or a server) connected thereto using the communication module 720.

The display module 760 (such as a screen 150 of FIG. 1) may include a panel 762, a hologram device 764, or a projector 766. The panel 762 may be, for example, a liquid-crystal display (LCD) or an active-matrix organic light-emitting diode (AM-OLED), and the like. The panel 762 may be implemented to be, for example, flexible, transparent, or wearable. The panel 762 and the touch panel 752 may be integrated into one module. The hologram device 764 may show a stereoscopic image in a space using interference of light. The projector 766 may project light onto a screen to display an image. The screen may be positioned, for example, in or out of the electronic device 700. According to an embodiment of the present disclosure, the display module 760 may further include a control circuit for controlling the panel 762, the hologram device 764, or the projector 766.

The interface 770 may include, for example, a high-definition multimedia interface (HDMI) 772, a universal serial bus (USB) 774, an optical interface 776, or a D-subminiature 778. The interface 770 may be included in, for example, a communication interface 160 shown in FIG. 1. Additionally or alternatively, the interface 770 may include, for example, a mobile high definition link (MHL) interface, an SD card/multimedia card (MMC) interface, or an infrared data association (IrDA) standard interface. The audio module 780 may convert a sound and an electric signal in dual directions. At least a part of components of the audio module 780 may be included in, for example, an input and output interface 140 shown in FIG. 1. The audio module 780 may process sound information input or output through, for example, a speaker 782, a receiver 784, an earphone 786, or the microphone 788, and the like. The camera module 791 may be a device which captures a still picture and a moving picture. According to an embodiment of the present disclosure, the camera module 791 may include one or more image sensors (such as a front sensor or a rear sensor), a lens (not shown), an image signal processor (ISP), or a flash (such as an LED or a xenon lamp).

The power management module 795 may manage power of the electronic device 700. Though not shown, the power management module 795 may include a power management integrated circuit (PMIC), a charger IC or a battery or fuel gauge. The PMIC may be mounted in, for example, an IC or an SoC semiconductor. A charging method may be classified as a wired charging method or a wireless charging method. The charger IC may charge the battery 796 and may prevent overvoltage or overcurrent from flowing in from a charger. According to an embodiment of the present disclosure, the charger IC may include a charger IC for at least one of the wired charging method or the wireless charging method. The wireless charging method may be, for example, a magnetic resonance method, a magnetic induction method, or an electromagnetic method, and the like. An additional circuit for wireless charging, for example, a coil loop, a resonance circuit, or a rectifier, and the like may be further provided.

The battery gauge may measure, for example, the remaining capacity of the battery 796 and voltage, current, or temperature thereof while the battery 796 is charged. The battery 796 may store or generate electricity, and may supply power to the electronic device 700 using the stored or generated electricity. The battery 796 may include, for example, a rechargeable battery or a solar battery. The indicator 797 may display a specific state of the electronic device 700 or a part (such as the AP 710) thereof, for example, a booting state, a message state, or a charging state, and the like. The motor 798 may convert an electric signal into mechanical vibration. Though not shown, the electronic device 700 may include a processing unit (such as a GPU) for supporting a mobile TV. The processing unit for supporting the mobile TV may process media data according to standards, for example, a digital multimedia broadcasting (DMB) standard, a digital video broadcasting (DVB) standard, or a media flow standard, and the like.

According to various embodiments of the present disclosure, the electronic device may invite other electronic devices to the chat room using information of the AP. The invited electronic device may participate in the chat room using the information of the AP, thereby making it possible to reduce inconvenience in which the user of the electronic device must directly set the AP.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least a part of the electronic device (e.g., modules or the functions) or the method (e.g., operations) may be implemented with, for example, instructions stored in a computer-readable storage media which has a program module. When the instructions are executed by a processor (e.g., a processor 120 of FIG. 1), one or more processors may perform functions corresponding to the instructions. The computer-readable storage media may be, for example, the memory 130. At least a part of the programming module may be implemented (e.g., executed) by, for example, the processor 120. At least a part of the programming module may include, for example, a module, a program routine, sets of instructions, or a process, and the like, for performing one or more functions.

The computer-readable storage media may include magnetic media, such as a hard disc, a floppy disk, and a magnetic tape, optical media, such as a compact disc read only memory (CD-ROM) and a digital versatile disc (DVD), magneto-optical media, such as a floptical disk, and a hardware device, such as a ROM, a random access memory (RAM), a flash memory, and the like, which is particularly configured to store and perform program instructions (e.g., program modules). Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included. Operations executed by modules, program modules, or other elements according to various embodiments of the present disclosure may be executed by a successive method, a parallel method, a repeated method, or a heuristic method. Also, some operations may be executed in a different order or may be omitted, and other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A first electronic device comprising:
a user input reception device configured to receive a user input to request the first electronic device to generate a chat room;
a processor configured to generate the chat room for use by a plurality of electronic devices; and
a transmitter configured to:
broadcast information indicating that the chat room is generated, and
transmit, to an access point (AP) connected with the first electronic device, the information indicating that the chat room is generated.

2. The first electronic device of claim 1, wherein the information indicating that the chat room is generated is transmitted to other electronic devices connected to the AP through the AP.

3. The first electronic device of claim 1, wherein the information identifying that the chat room is generated comprises information to access to the chat room.

4. The first electronic device of claim 1, further comprising:
a receiver configured to receive a request to transmit information of the chat room from a second electronic device which receives the broadcasted information.

5. The first electronic device of claim 4, wherein the transmitter is configured to transmit the information of the chat room and information about the AP to the second electronic device.

6. The first electronic device of claim 1, wherein broadcasting the information is performed via a BLUETOOTH® low energy (BLE) network.

7. The first electronic device of claim 4, wherein the receiver is configured to receive a request to perform BLUETOOTH® (BT) pairing from the second electronic device, and wherein the request to transmit the information of the chat room is received through a BT network.

8. The first electronic device of claim 1, wherein the AP is the first electronic or is included in the first electronic device.

9. A second electronic device comprising:
a receiver configured to:
receive information to indicate that a chat room is generated from a first electronic device through an AP connected with the second electronic device, or
receive the information in a broadcasting manner from the first electronic device, wherein the first electronic device is configured to broadcast the information to indicate that the chat room is generated and transmit the information to an access point (AP) connected with the first electronic device.

10. The second electronic device of claim 9, wherein when the first electronic device and the second electronic device connect to the same AP, the receiver is configured to receive, through the AP, the information to indicate that the chat room is generated.

11. The second electronic device of claim 9, further comprising:
a transmitter configured to transmit a request to transmit information of the chat room to the first electronic device when the information to indicate that the chat room is generated is received in the broadcasting manner, wherein the receiver is configured to receive the information of the chat room and information about the AP connected with the first electronic device.

12. The second electronic device of claim 11, further comprising:
a display configured to display the received information of the chat room on a screen of the second electronic device;
a user input reception device configured to receive a user input on the displayed information of the chat room; and
a processor configured to connect to the AP using the received information of the AP and to access the chat room using the received information of the chat room.

13. The second electronic device of claim 11, further comprising:
a processor configured to determine whether the received information of the AP is for an AP that is connectable with the second electronic device and to determine not to display the received information of the chat room on the screen when the received information of the AP is for an AP that is not connectable with the second electronic device.

14. The second electronic device of claim 12, wherein when the connection to the AP fails because network units are different from each other, the processor is configured to attempt to connect to an Internet protocol (IP)/port connected with the AP.

15. A method to indicate that a chat room is generated, the method comprising:
receiving a user input to request a first electronic device to generate the chat room;
generating the chat room for use by a plurality of electronic devices;
broadcasting information to indicate that the chat room is generated; and
transmitting the information to indicate that the chat room is generated to an access point (AP) connected with the first electronic device.

16. The method of claim 15, further comprising transmitting the information indicating that the chat room is generated to other electronic devices connected to the AP through the AP.

17. The method of claim 15, wherein the information identifying that the chat room is generated comprises information to access to the chat room.

18. The method of claim 15, further comprising receiving a request to transmit information of the chat room from a second electronic device which receives the broadcasted information.

19. The method of claim 18, further comprising transmitting the information of the chat room and information about the AP to the second electronic device.

20. The method of claim 15, wherein broadcasting the information comprises broadcasting the information via a BLUETOOTH® low energy (BLE) network.
